(19) United States
(12) Patent Application Publication
(10) Pub. No.: US 2020/0064002 A1
(43) Pub. Date: Feb. 27, 2020

(54) DIRECT WIRELESS CONNECTION BETWEEN MOBILE SERVICE TOOL AND A ROOFTOP HEATING VENTILATION AND COOLING SYSTEM

(71) Applicant: Carrier Corporation, Palm Beach Gardens, FL (US)

(72) Inventors: Craig Drew Bogli, Avon, CT (US); Tony Spath, West Hartford, CT (US); Yrinee Michaelidis, Farmington, CT (US); Tadeusz Pawel Witczak, Farmington, CT (US)

(21) Appl. No.: 16/546,834

(22) Filed: Aug. 21, 2019

Related U.S. Application Data
(60) Provisional application No. 62/720,640, filed on Aug. 21, 2018.

(51) Int. Cl. F24F 11/30; F24F 11/65; G05B 15/02; H04L 29/06

(52) U.S. Cl. CPC F24F 11/30; F24F 11/65; H04L 63/0876; H04L 63/0853; G05B 15/02

(57) ABSTRACT

A method and user device for operating a HVAC system. The method includes identifying automatically a controller of an HVAC system and initiating communication between a user device and the controller of the HVAC system or identifying automatically a user device of an HVAC system and initiating communication between a controller and the user device of the HVAC system, operably connecting the user device to the controller, and communicating with the controller to control an aspect of operation of the HVAC system.

### CROSS-REFERENCE TO RELATED APPLICATIONS

This application claims the benefit of U.S. provisional patent application Ser. No. 62/720,640, filed Aug. 21, 2018, the entire contents of which are incorporated herein by reference.

### TECHNICAL FIELD

The subject matter disclosed herein relates generally to connection to and communication with heating ventilation and cooling (HVAC) systems, and more particularly to automatic connection and communication with a rooftop HVAC system (RTU).

### BACKGROUND

Newer commercial HVAC RTUs are complex. These RTUs offer customers greater customization and features, are easier to use, troubleshoot, and install, and in some cases are needed to comply with regulatory requirements. To offer these additional capabilities, the RTUs often utilize modern microprocessors.

Commercial HVAC RTUs are controlled, configured, serviced, and troubleshot through these conventional user interfaces. For example, a user interface may offer only a low-resolution text display that can show only a single line of text, or use conventional serial or wireless interfaces. A user may be expected to use such a display to navigate through menus of the many features offered by the RTU. In contrast to their advanced capabilities, existing RTU user interfaces are difficult to use and often result in user frustration.

Considerations peculiar to commercial HVAC RTUs have limited development of more advanced user interfaces. First, the RTUs, and consequently their user interfaces, are located outdoors. Many solutions are unsuited for the outdoor environments. Second, existing RTU user interfaces are relatively simple and don't always employ the hardware components for a modern user interface, such as a large screen, would be a significant increase in the cost of the RTU. Third, generally, the only means for a technician to view the status of the controller in the RTU for fault codes or to access connection ports is to physically open the controller cabinet and look at the blinking status LED or make connections to the communications ports. In some cases, just gaining physical access to the RTU is a time consuming effort. Moreover, installations with multiple rooftops on a single roof make wireless connections more difficult to ensure connection to the right RTU. Finally, typical RTUs need user interaction only sporadically after installation. The advanced user interface would only be used for a brief part of the lifetime of the RTU.

It would be desirable if a RTU could offer a modern, user-friendly user interface and automatic connection to one without significant changes to the hardware of the RTU. Such a user interface could reduce the time a technician spends interacting with a RTU, which in turn could increase the technician's productivity at installation, service, and troubleshooting.

### BRIEF SUMMARY

According to an embodiment, described herein is an HVAC system configured to interface with a user device. The HVAC system including a controller, the controller configured operate at least one unit of an HVAC system, at least one of: the controller configured to conduct a first automatic identification of the user device and initiate communication between the controller and the user device or the user device configured to conduct a second automatic identification the controller and initiate communication between the user device and the controller. The controller operably connecting to the user device, and the user device configured to operably communicate with the controller to control an aspect of operation of the HVAC system.

In addition to one or more of the features described above or below, or as an alternative, further embodiments could include the user device configured to provide a graphical user interface to the HVAC system, receive user input for performing a function of the HVAC system, and instruct the HVAC system to perform the function.

In addition to one or more of the features described above or below, or as an alternative, further embodiments could include that the user device comprises at least one of a mobile device, a smartphone, PDA, tablet, or wearable device.

In addition to one or more of the features described above or below, or as an alternative, further embodiments could include that the controller is at least one of a unit controller or a system controller configured to control one or more units of the HVAC system.

In addition to one or more of the features described above or below, or as an alternative, further embodiments could include that at least one of the user device and the controller are configured to communicate with the HVAC system over at least one of a wired connection and a wireless connection.

In addition to one or more of the features described above or below, or as an alternative, further embodiments could include that the wireless connection is at least one of Bluetooth, WiFi, NFC, and Cellular.

In addition to one or more of the features described above or below, or as an alternative, further embodiments could include that the aspect of operation includes at least one of commissioning a component of the HVAC system, programming a component of the HVAC system, diagnosing the HVAC system, displaying, modifying or changing variable of the HVAC system, updating software of the HVAC system, wherein the variable comprises a parameter for a compressor, blower, economizer, or fan of the HVAC system.

In addition to one or more of the features described above or below, or as an alternative, further embodiments could include that the first automatic identification or the second automatic identification is based on at least one of a credential of a user, a profile of a user, and proximity of the user device to an HVAC system component.

In addition to one or more of the features described above or below, or as an alternative, further embodiments could include that proximity is based on at least one of GPS location, Bluetooth beacon locations, wireless triangulation.

In addition to one or more of the features described above or below, or as an alternative, further embodiments could include that at least one of the unit of the or the HVAC system comprises an outdoor commercial rooftop unit.

Also described herein in another embodiment is a method for operating a HVAC system. The method includes identifying automatically a controller of an HVAC system and initiating communication between a user device and the controller of the HVAC system or identifying automatically a user device of an HVAC system and initiating communication between a controller and the user device of the HVAC system, operably connecting the user device to the controller, and communicating between the user device and the controller to control an aspect of operation of the HVAC system.

In addition to one or more of the features described above or below, or as an alternative, further embodiments could include the user device configured to provide a graphical user interface on the user device to the HVAC system, receive user input via the user device for performing a function of the HVAC system, and instruct the HVAC system via the user device to perform the function.

Other aspects, features, and techniques of embodiments will become more apparent from the following description taken in conjunction with the drawings.

### BRIEF DESCRIPTION OF THE DRAWINGS

The described subject matter is particularly pointed out and distinctly claimed in the claims at the conclusion of the specification. The foregoing and other features, and advantages are apparent from the following detailed description taken in conjunction with the accompanying drawings in which:

FIG. 1 depicts components of a HVAC system which may operate in accordance with an embodiment;

FIG. 2 depicts components of a mobile device which may operate in accordance with an embodiment;

FIG. 3 depicts a wireless HVAC control system in accordance with an embodiment;

FIG. 4 depicts a HVAC control system with network connection functionality in accordance with an embodiment;

FIG. 5 depicts a HVAC control system with direct network connection functionality in accordance with an embodiment; and

FIG. 6 depicts a flowchart of a method of communication with an RTU in accordance with an embodiment.

### DETAILED DESCRIPTION

In general, embodiments herein relate to a wireless connection to the HVAC RTU system that allows a technician to obtain performance information from a nearby location (such as inside the building, in the parking lot, on an adjacent rooftop, or on the same rooftop with several other RTUs) without physically touching the HVAC RTU. A wireless point of access to the RTU can be at the RTU itself (inside the controller cabinet) or at a thermostat or controller, which can then relay the data to/from the controller for the RTU. An individual wireless connection is WiFi® (either private network, or part of the building wireless WiFi network) or Bluetooth® can be employed to provide the wireless access. Moreover, wireless access with automated connectivity to the RTU controller could also allow for the ability to rapidly update configuration parameters to the controller, thermostat, or diagnostic monitoring system and the like. By using wireless communication with proximity ranging sensing, the RTU can authenticate that a remote/mobile device which is interrogating the controller is in close proximity to the RTU—especially when performing critical tasks such as validating performance after specific maintenance tasks. This ensures that the devices are secure against hackers who don't have physical rooftop access. In another embodiment, technicians who have been assigned to a particular RTU for repair or maintenance may be granted permissions for remote access to fault logs and performance information, regardless of being in close proximity to the equipment. Examples of criteria for proximity access control may include, but not be limited to, WIFI and/or Bluetooth signal strength measurements, NFC (Near Field Communication), GPS based distance difference calculation (e.g., GeoFencing), Cellular triangulation measurement, and the like. In addition to detecting when the technician is in close proximity to the RTU, the first three methods can also be used to detect when the technician is in close proximity to a particular thermostat.

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended. The following description is merely illustrative in nature and is not intended to limit the present disclosure, its application or uses. It should be understood that throughout the drawings, corresponding reference numerals indicate like or corresponding parts and features. As used herein, the term controller refers to processing circuitry that may include an application specific integrated circuit (ASIC), an electronic circuit, an electronic processor (shared, dedicated, or group) and memory that executes one or more software or firmware programs, a combinational logic circuit, and/or other suitable interfaces and components that provide the described functionality.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in Figure X may be labeled “Xa” and a similar feature in Figure Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

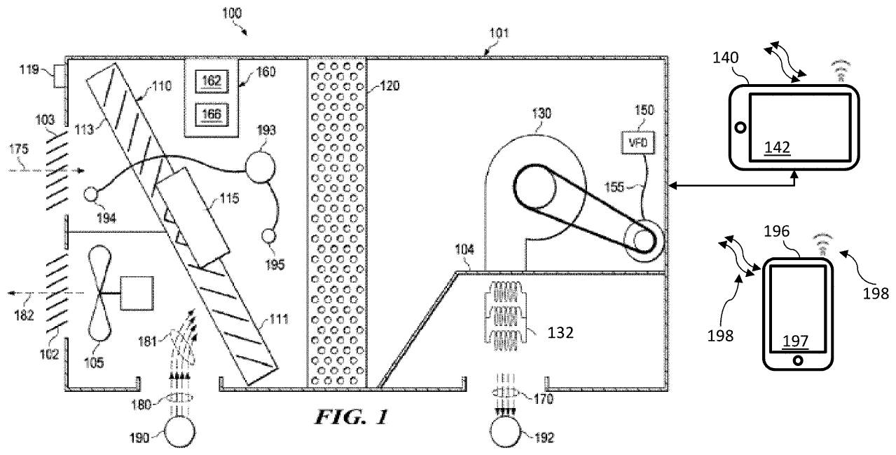

Referring to FIG. 1, depicted is a block diagram of an illustrative HVAC system 100 which may operate in accordance with an embodiment. HVAC system 100 includes enclosure 101 (e.g., a cabinet or housing) with openings for exhaust air, ventilation air, return air and supply air. Enclosure 101 includes exhaust vents 102 and ventilation vents 103 at the corresponding exhaust air and ventilation air openings. Within enclosure 101, HVAC system 100 also includes exhaust fan 105, economizer 110, cooling element 120, indoor fan or blower 130, and heating element 132. HVAC system 100 also includes a compressor (not shown).

Additionally, HVAC system 100 includes fan controller 150 and HVAC controller 160. Fan controller 150 is coupled to blower 130 via cable 155. Cable 155 is a conventional cable used with HVAC systems. HVAC controller 160 can be connected (not illustrated) to various components of HVAC system 100, including temperature sensor 119 for determining outside air temperature, via wireless or hardwired connections for communicating data. Conventional cabling or wireless communications systems may be employed. Also included within enclosure 101 is partition 104 that supports blower 130 and provides a separate heating section.

HVAC system 100 is a RTU (roof top unit). One skilled in the art will understand that the HVAC system 100 can include other partitions or components that are typically included within an HVAC system such as an RTU. While the embodiment of the HVAC system 100 is discussed in the context of a RTU, the scope of the disclosure includes other HVAC applications that are not roof-top mounted.

Blower 130 operates to force air stream 170 into a structure, such as a building, being conditioned via an unreferenced supply duct. Return airstream 180 from the building enters the system 100 at an unreferenced return duct.

First portion 181 of the air stream 180 re-circulates through economizer 110 and joins the air stream 170 to provide supply air to the building. A second portion of the air stream 180 is air stream 182 that is removed from HVAC system 100 via exhaust fan 105.

Economizer 110 operates to vent a portion of return air 180 and replace the vented portion with air stream 175. Thus air quality characteristics such as CO2 concentration and humidity may be maintained within defined limits within the building being conditioned. Economizer 110 includes an indoor damper 111, an outdoor damper 113 and an actuator 115. Actuator 115 drives (opens and closes) the indoor and outdoor dampers 111 and 113 (i.e., the blades of the indoor and outdoor dampers 111 and 113). Though economizer 110 includes two damper assemblies, one skilled in the art will understand that the concepts of the disclosure also apply to those economizers or devices having just a single damper assembly, an outdoor damper assembly.

HVAC controller 160 includes an interface 162 and firmware 166. Firmware 166 may be implemented on a processor and/or a memory of the HVAC controller 160. Firmware 166 may direct the operation of or at least part of the operation of the HVAC system 100. Firmware 166 may generate control signals that are transmitted to the various components of the HVAC system 100 to direct the operation of those components. Firmware 166 may generate the control signals in response to feedback data that is received from the various sensors and/or components of the HVAC system 100.

HVAC controller 160 may have a communication interface, e.g., USB port, Etherport, Modbus port, and the like, which connects to a USB device for the HVAC system 100 to communicate with. The USB port may receive a USB storage device containing a firmware update for firmware 166.

Interface 162 receives feedback data from sensors and components of the HVAC system 100 and transmits control signals thereto. As such, the HVAC controller 160 may receive feedback data from, for example, the exhaust fan 105, blower 130 and/or fan controller 150, economizer 110 and temperature sensor 119, and transmit control signals thereto if applicable. One skilled in the art will understand that the location of the HVAC controller 160 can vary with respect to the HVAC system 100.

Interface 162 may be a conventional interface that employs a known protocol for communicating (i.e., transmitting and receiving) data. Interface 162 may be configured to receive both analog and digital data. The data may be received over wired, wireless or both types of communication mediums. In some embodiments, a communications bus may be employed to couple at least some of the various operating units to interface 162. Though not illustrated, the interface 162 includes input terminals for receiving feedback data.

The feedback data received by the interface 162 includes data that corresponds to a pressure drop across outdoor damper 113 and a damper position of the economizer 110 as well as various temperatures and pressures employed to control the HVAC system 100. For example, in some embodiments outside air temperature as sensed by a temperature sensor 119, suction and discharge pressures associated with the compressor, and refrigerant temperatures. In some embodiments, the feedback data also includes the supply airflow rate. Various sensors of the HVAC system 100 are used to provide this feedback data to the HVAC controller 160 via interface 162. In some embodiments, return pressure sensor 190 is positioned in the return air opening to provide a return static pressure. Return pressure sensor 190 measures the static pressure difference between the return duct and air outside of the HVAC system 100. In one embodiment, a supply pressure sensor 192 is also provided in the supply air opening to indicate a supply pressure to the HVAC controller 160. Supply pressure sensor 192 measures the static pressure difference between the return duct and the supply duct. Pressure sensor 193 is used to provide the pressure drop across outdoor damper 113 of the economizer 110. Pressure sensor 193 determines the static pressure difference across outdoor damper 113. Pressure sensor 193 includes first input 194 and second input 195 for receiving the pressure on each side of outdoor damper 113. The pressure and temperature sensors discussed herein can be conventional pressure sensors typically used in HVAC systems.

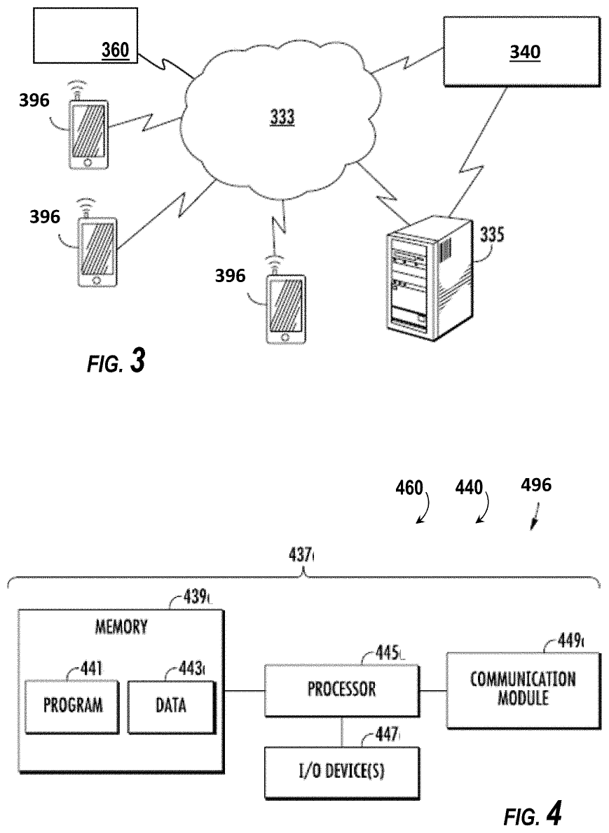

The HVAC system 100 may include one or more computing devices, such as a controller 160. The controller 160 may be configured to control various aspects associated with the heating, cooling, and ventilation functions associated with the HVAC system 100. It is understood that the HVAC system 100 may utilize more than one controller 160, and that each controller 160 may control portions of the functions of the HVAC system 100. The HVAC system 100 also includes one or more control panels e.g., thermostats, temperature/humidity sensors and the like distributed in the interior space to be conditioned at a lobby in the building and one or more floors. The fixtures may also include a control panel passenger interface where a user may enter a programming information and setpoints associated with the HVAC system 100. The controllers e.g., 160 may include a processor, memory, and communication module(s), as shown in FIG. 4. As described below, the processor can be any type or combination of computer processors, such as a microprocessor, microcontroller, digital signal processor, application specific integrated circuit, programmable logic device, and/or field programmable gate array. The memory can be a non-transitory computer readable storage medium tangibly embodied in the controller 160 or control panel including executable instructions stored therein, for instance, as firmware 166. The communication module may implement one or more communication protocols as described in further detail herein, and may include features to enable wired or wireless communication with external and/or remote devices separate from the controller 160, control panel, and the like. The controller 160, and the control panel 140 may further include a user interface (e.g., a display screen, a microphone, speakers, input elements such as a keyboard or touch screen, etc.) as known in the art and as described herein with respect to FIG. 4. The control panel 140 is configured to communicate with the controller 160 as may be required to control operations associated with the HVAC system 100.

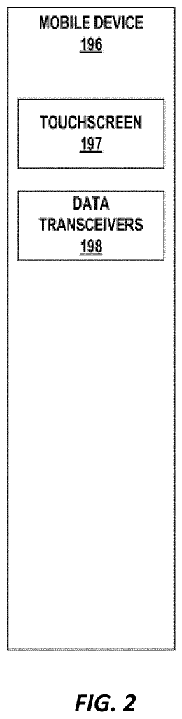

Referring to FIG. 2, depicted is a block diagram of an exemplary user device 196 which may operate in accordance with one or more embodiments. User device 196, such as a mobile device (e.g., smart phone, smart watch, wearable technology, laptop, tablet, etc.). The user device 196 may include a processor, memory, and communication module(s), as shown in FIG. 4. The user device 196 may further include a user interface (e.g., a display screen, a microphone, speakers, input elements such as a keyboard or touch screen 197, etc.) as known in the art and as described herein with respect to FIG. 4. User device 196 might typically be consumer-grade smartphones and tablets, as may be employed by an HVAC technician. User device 196 may include touchscreen 197 and is capable of running applications offering a modern user interface. User device 196 may also include one or more communication data transceivers 198. Data transceivers 198 may permit mobile device 196 to wirelessly access the Internet using a cellular network (e.g. 3G or 4G) or wireless local area network (e.g. IEEE 802.11, Wi-Fi,).

By temporarily incorporating user device 196 to present a user interface, HVAC system 100 can overcome many of the problems that have thus far hindered HVAC user interfaces. First, because mobile device 196 only needs to be present when a technician is, touchscreen 197 does not need to withstand an outdoor environment long-term. Second, because many HVAC technicians already own and carry a mobile devices for other communication purposes and many RTUs in HVAC systems already utilize modern microprocessors, the additional cost of providing a communication interface and user interface to the HVAC system 100 is limited. Third, because the user device 196 is carried by the technician rather than attached to HVAC system 100, the usage of the user device 196 will match the workload of the technician rather than the needs of any one RTU.

A user device 196, and controller e.g., 160, and control panel 140 can communicate with one another, e.g., as shown in FIG. 3 where the corresponding reference numerals have been modified. For example, in an embodiment one or more user device(s) 396 (similar to user device 196), control panel 340 (similar to control panel 140), and the controller 360 (similar to controller 160) may communicate with one another when proximate to one another (e.g., within a threshold distance). The user device 396, control panel 340, and the controller 360 may communicate over a network 333, that may be wired or wireless. Wired communication can be conventional including standard hard wiring or Ethernet. Wireless communication networks can include, but are not limited to, Wi-Fi, short-range radio (e.g., Bluetooth), near-field radio frequency (NFC), infrared (IR), cellular network, etc. In some embodiments, the controller 360, and/or control panel 340 may include, or be associated with (e.g., communicatively coupled to) one or more networked building elements 335, such as computers, control panel 340, mobile devices 396, sensors, actuators, beacons, bridges, routers, network nodes, etc. The networked building element 335 may also communicate directly or indirectly with the user devices 396 using one or more communication protocols or standards (e.g., through the network 333).

For example, the networked building element 335 may communicate with the user devices 396 using near-field communications (NFC) (e.g., network 333) and thus enable communication between the user devices 396 and the controller 360. In some embodiments, the controller 360 may establish communication with one or more user devices 396 that are outside of the structure/building. Such connection may be established with various technologies including GPS, triangulation, or signal strength detection, by way of non-limiting example. Such technologies that allow communication can provide users and the system(s) described herein more time to perform the described functions. In example embodiments, the user devices 396 communicate with the controller 360 over multiple independent wired and/or wireless networks. Embodiments are intended to cover a wide variety of types of communication between the user devices 396 and the controller 360, and embodiments are not limited to the examples provided in this disclosure.

The network 333 may be any type of known communication network including, but not limited to, a wide area network (WAN), a local area network (LAN), a global network (e.g. Internet), a virtual private network (VPN), a cloud network, and an intranet. The network 333 may be implemented using a wireless network or any kind of physical network implementation known in the art. In another embodiment, the network 333 is a daisy chained Ethernet network between the user devices 396, controller 360, and the control panel 340 as described further herein. The user devices 396 and/or the networked building element 335 may be coupled to the controller 360 through multiple networks 333 (e.g., cellular and Internet) so that not all user devices 396 and/or the networked building elements 335 are coupled to the controller 360 through the same network 333. One or more of the user devices 396 and the controller 360 may be connected to the network 333 in a wireless fashion. In one non-limiting embodiment, the network 333 is the Internet and one or more of the user devices 396 execute a user interface application (e.g. and App or a web browser) to contact the controller 360 through the network 333.

Embodiments provided herein are directed to apparatuses, systems, and methods for connecting to and controlling n HVAC system, e.g., a connection request made by a user device 396 and transmitted through the network 333 to the controller 360 to connect to the HVAC system 100, and in particular either the controller 360 or control panel 340 and provide service, conduct diagnostics, evaluate fault codes, modify system performance or make service updates. The service connection may be initiated by a user device 396 in the example of a mobile device controlled by and/or associated with a user, in a passive or active manner In some embodiments, user device 396 may be operative in conjunction with a Transmission Control Protocol (TCP) and/or a User Datagram Protocol (UDP). In some embodiments, a request for service may be authenticated or validated based on a location of the user device 396. In some embodiments, a connection may be fulfilled in accordance with one or more profiles, such as one or more user or mobile device profiles. In some embodiments the profiles may be registered as part of a registration process. In some embodiments, an HVAC system 100 may be registered with a service provider.

Referring now to FIG. 4, schematic block diagram illustrations of example computing systems 437 as may be employed for a user device 496, controller 460, control panel 440 respectively, are shown. The computing system 437 may be representative of computing elements or components of user devices e.g., 196, 396, networked building elements 335, controllers 460 (e.g., 160), control panels 440 (e.g. 140), etc. as employed in embodiments of the present disclosure. The computing system 437 can be configured to operate the user device 496, RTU controller 460, control panel 440 etc. including, but not limited to, operating and controlling a touch-screen display e.g., 197, 142 to display various outputs and receive various inputs from a user's interaction with the touch-screen display 197, 142. The computing system 437 may be connected to various elements and components within a building that are associated with operation of an HVAC system 100.

As shown, the computing system 437 includes a memory 439 which may store executable instructions and/or data. The executable instructions may be stored or organized in any manner and at any level of abstraction, such as in connection with one or more applications, apps, programs, processes, routines, procedures, methods, etc. As an example, at least a portion of the instructions are shown in FIG. 4 as being associated with a program 441. The memory 439 can include RAM and/or ROM and can store the program 441 thereon, wherein the program 441 may also include an operating system and/or applications to be used on the user device 496, controller 460, control panel 440 and the like. Further, the memory 439 may store data 443. The data 443 may include profile or registration data (e.g., in a user device 196, 396, 496), a device identifier, or any other type(s) of data, product configuration and the like. The executable instructions stored in the memory 439 may be executed by one or more processors, such as a processor 445, which may be a mobile processor in the user device 496 mobile application or a standard processor as may be employed in the controller 460, or control panel 440. The processor 445 may be operative on the data 443 and/or configured to execute the program 441. In some embodiments, the executable instructions can be performed using a combination of the processor 445 and remote resources (e.g., data and/or programs stored in the cloud (e.g., remote servers).

The processor 445 may be coupled to one or more input/output (I/O) devices 447. In some embodiments, the I/O device(s) 447 may include one or more of a physical keyboard or keypad, a touchscreen or touch panel (e.g. 197, 142), a display screen, a microphone, a speaker, a mouse, a button, e.g., parts or features of a telephone or mobile device (e.g., a smartphone). For example, the I/O device(s) 447 may be configured to provide an interface to allow a user to interact with the user device 496. In some embodiments, the I/O device(s) 447 may support a graphical user interface (GUI) and/or voice-to-text capabilities for the user device 496.

The components of the computing system 437 may be operably and/or communicably connected by one or more buses. The computing system 437 may further include other features or components as known in the art. For example, the computing system 437 may include one or more communication modules 449, e.g., transceivers and/or devices configured to receive information or data from sources external to the computing system 437. In one embodiment, the communication modules 449 of the user device 496 can include a near-field communication chip (e.g., Bluetooth, Wi-Fi, etc.) and a cellular data chip, as known in the art. In some embodiments, the computing system 437 may be configured to receive information over a network (wired in some examples or wireless in others), such as network 333 shown in FIG. 3. The information received over the network 333 may be stored in the memory 439 (e.g., as data 443) and/or may be processed and/or employed by one or more programs or applications (e.g., program 441).

The computing systems 437 may be used to execute or perform embodiments and/or processes described herein, such as within and/or on the controller 460, control panel 440 and user device 496 to enable a user to conduct installation, commissioning, service calls, diagnostics and the like to the HVAV system 100.

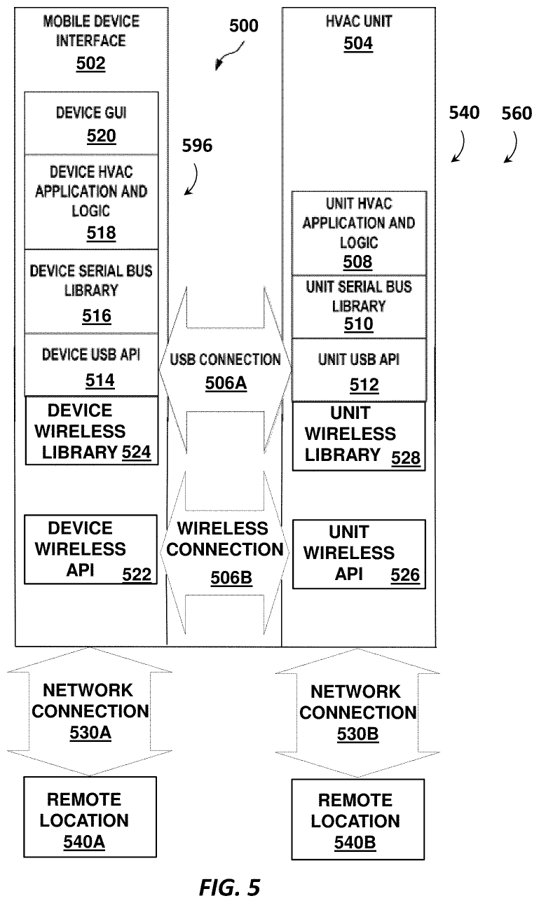

With reference to FIG. 5, depicted is a HVAC control system 500 (part of user device 596 and controller 560 or control panel 540), in accordance with an exemplary embodiment. HVAC system 500 includes mobile device interface 502 as part of mobile device 596 communicates with the HVAC system (e.g., similar to HVAC system 100, but denoted in this figure as 504). Mobile device interface 502 and HVAC system 504 may communicate through communication interface 506A, e.g., in one instance a Universal Serial Bus (USB) connection 506A and/or a wireless connection 506B e.g., WiFi, Bluetooth, and the like. Mobile device interface 502 may be a mobile device, such as user device 596, (e.g., similar to 196), running an application that enables the user device 596 to communicate with HVAC system 504. Mobile device interface 502 may be part of a smartphone or tablet and the like as described herein, such as a technician's personal user device 596 or one provided to the technician for the technician's work.

The HVAC unit 504 may have the same hardware components as HVAC system 100 or another conventional HVAC RTU, except that its HVAC controller processor may run system HVAC application and logic 508 to enable it to interact with mobile device interface 502.

HVAC RTUs may receive firmware updates from USB storage devices through USB connections. HVAC unit 504 may utilize unit serial bus library 510 and unit USB Application Programming Interface (API) 512, conventionally for installing these updates, to communicate over USB connection 506A. Unit HVAC application and logic 508, unit serial bus library 510, and unit USB API 512 may all be part of the firmware (e.g., 166) of the HVAC controller 160, of HVAC system 100, 500.

User devices 196, 496 are likewise also commonly able to communicate over USB connections like USB connection 506A. Mobile device interface 502 may utilize device a USB API 514 and a device serial bus library 516 to communicate over a USB connection 506A. A unit serial bus library 510 and a device serial bus library 516 may be specialized serial bus libraries for communications to and from a HVAC unit 504. Unit serial bus library 510 and device serial bus library 516 may follow a protocol specifically designed for such communications. Likewise, user devices 196, 496, 596 are likewise also able to communicate over wireless connections like wireless connection 506B such as described herein with respect to FIGS. 2, 3, and 4. Mobile device interface 502 may also utilize a user device wireless API 522 and a device wireless library 524 to communicate with a unit wireless API 526 and a unit wireless library 528 over the wireless connection 506B. Unit wireless library 528 and the device wireless library 524 may be specialized wireless libraries for communications to and from a HVAC unit 504. Unit wireless library 528 and device wireless library 524 may follow a protocol specifically designed for such communications.

Mobile device interface 502 includes a processor running a device HVAC application and logic 518 to enable mobile device interface 502 to communicate with HVAC unit 504. The device HVAC application and logic 518 may provide a device Graphical User Interface (GUI) 520. The GUI 520 is a user interface to user device 596 and thereby to HVAC unit 504.

Through device GUI 520, a user may operate the functions of HVAC system 504. Mobile device interface 502 may receive user input for performing a function, testing, interrogation, diagnostics and the like of HVAC unit 504. Mobile device interface 502 may then instruct HVAC unit 504 and thereby the HVAC system 500 to perform the function.

In particular, device GUI 520 may be an interface for the user/service technician to perform the functions such as commissioning, displaying and changing variables, diagnostics, updates, and the like for the HVAC system 500. These variables may include operational parameters such as evaluating characteristics of the various components of the HVAC system 500 including, but not limited to the compressor, blower, economizer, and fan, such as on and off delays and safety limits or thresholds for alerts. The variables may include whether specific features and modes of HVAC system 500 are enabled or disabled. The variables may include minimum and maximum airflow values, blower speeds, and control algorithm parameters. It should be appreciated that other parameters and variables are possible. Additional functions device GUI 520 may be an interface for performing include initial commissioning of HVAC system 500 and configuring network communications for HVAC unit 504. It should be understood and appreciated that various other functions are also possible.

Mobile device interface 502 and/or HVAC unit 504 may be configured to send and receive data over the network connection 506 and send the data to a network location 540A and 540B over network connections 530A and 530B. Mobile device interface 502 may also receive data from either network location 540A over network connection 530A and send the data to HVAC system 504 over connection 506A, 506B. Likewise, HVAC unit 504 may also receive data from network location 540B over network connection 530B and send the data to the mobile device interface 502 over connection 506A or 506B.

Network location 540A, 540B may provide customer support and technical support resources to a technician using mobile device interface 502. Mobile device interface 502 may obtain configuration data from HVAC system 504 and send this configuration data to network location 540A, 540B. In response, network location 540A, 540B may send mobile device interface 502 customer support and technical support resources appropriate for the configuration of HVAC system 500. Moreover, network location 540A, 540B may be a service platform online gateway, such as a website, for servicing HVAC RTUs. Network location 540A, 540B may offer an online interface to HVAC system 500. A remote user may use network location 540A, 540B to service HVAC system 500, such as performing remote diagnostics, remote data analysis, and remote troubleshooting. The remote user may use network location 540A, 540B to create remote service verification reports.

A remote user may send firmware updates to the RTU, e.g., HVAC unit 504 through network connection 530A and/or connection 530B, rather than connecting a USB device, wired or wireless connection from the mobile device interface 502 to the HVAC unit 504. Alternatively, a user of mobile device interface 502 may download a firmware update from network location 540A and provide the firmware update to HVAC system 504 over connection 506A or 506B. Either way, the firmware update received by HVAC unit 504 can always be the most current version available at network location 540A, 540B. In contrast, the prior methods, sending a technician with a storage device to HVAC system 500, had the potential for the storage device to contain an out-of-date firmware update.

In an embodiment, the HVAC control systems 500, the mobile device application of mobile device interface 502 may interface with other applications in the user device 596. For example, the application may interact with an email application in the mobile device to email service reports. The application may interface with a web browser in the mobile device to send HVAC system 500 configuration data and registration data to a website portal. The application may also interface with a positioning/mapping application to provide positioning information regarding the user device 596 as well as any given RTU of the HVAC system e.g., 500. The application may provide HVAC system 500 configuration data to another mobile app which offers service quotes and part prices.

In an embodiment, the HVAC control systems 500, the mobile device application of mobile device interface 502 may execute a methodology to interface with a positioning/mapping application to provide positioning information regarding the mobile device 596 as well as any given RTU e.g., a specific HVAC unit 504 of the HVAC system e.g., 500. The application enables automated connection to a selected RTU e.g., 504 in an HVAC system 100, 500. In yet a further embodiment, the application facilitates the automatic connection of the mobile device 596 to a given RTU e.g., 504, and particularly the controller e.g., 160, 360 thereof an HVAC system 500, 100 based on proximity. For example, in an embodiment, the HVAC system 100 may include a plurality of RTU's e.g., 504 on the same roof. The mobile device interface 502 may be configured to automatically identify the RTU e.g., HVAC unit 504 in closest proximity based on location information associated with the user device 596. Once located the user device 196, 396 automatically establishes communication with the RTU in closest proximity In another embodiment, the user device 596 may display via the device GUI a selection of RTU's in the immediate vicinity for potential connection. The technician employing the user device 596 may then readily select the RTU e.g., a particular HVAC unit 504 for connection.

In an embodiment, a wireless connection to the HVAC RTU allows a technician to obtain performance information from a nearby location (such as inside the building, in the parking lot, on an adjacent rooftop, or on the same rooftop with several other RTUs) even without physically touching the HVAC RTU. Wireless communication can be established with the controller 160, 360, 560 or via a thermostat or control panel 140, 340, 540, which can then relay the data to/from the controller 160, 360 for the RTU. By using wireless communication with proximity ranging sensing, the RTU e.g., HVAC unit 504 and more particularly a given controller 160, 560 can authenticate that a user device 196, 396, 596 is in close proximity to the RTU e.g., HVAC unit 504, especially when performing critical tasks such as validating performance after specific maintenance tasks. This methodology ensures that the user devices 196, 396, 596 and the controller 160, 360 are secure against hackers who don't have physical rooftop access. In another embodiment, technicians who have been assigned to a particular RTU for repair or maintenance may be granted permissions for remote access to fault logs and performance information, regardless of being in close proximity to the equipment. While GPS positioning has been employed to describe a particular example of proximity based connection other examples are possible. For examples some criteria for proximity access control to the HVAC system 500, 100 and specifically controller 560, 160 may include, but not be limited to, WiFi and/or Bluetooth signal strength measurements, NFC (Near Field Communication), cellular triangulation measurement, and the like, in addition to GPS based distance difference calculation (e.g., GeoFencing). In addition to detecting when the technician is in close proximity to the RTU, e.g., a given HVAC unit 504 the first three methods can also be used to detect when the technician is in close proximity to a particular thermostat/control panel e.g., 540 for an HVAC system 500.

Moreover, it will be appreciated that an existing HVAC system may be easily retrofitted to work in HVAC systems 500. As previously discussed, a suitable unit serial bus library 510 and unit USB API 512 already exists in many HVAC units 504 for receiving firmware updates. A legacy HVAC system may only need to be given a firmware update containing unit HVAC application and logic 508, or wireless library 528 and API 526 as an example.

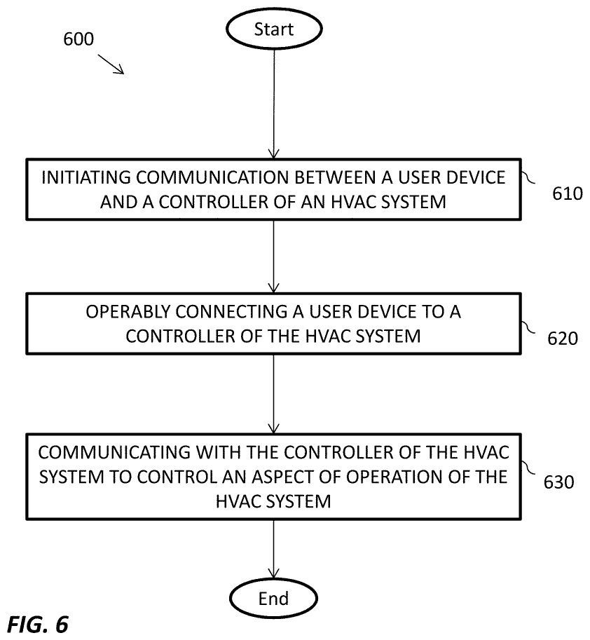

Turning now to FIG. 6 depicting a flowchart of the described methodology 600 of automated wireless connection between a user device e.g., 196 and an HVAC system 100, 500. In an embodiment, methodology 600 is initiated at process step 610 with the mobile device 196, 596 is configured with an app (e.g., 518 among others) that permits communication with a controller 160, 560 of an HVAC system 100,500. In an embodiment, the communication is wireless employing WiFi or Bluetooth as described herein. In some embodiments the connection is via a cellular communication. In some embodiments, the communication is via a remote connection. The method 600 continues at process step 620 with operably connecting the user device 196,596 to a particular controller e.g., a particular one of 160, 560 or 140, 540 of the HVAC system 100, 500. In an embodiment the connection is automatic based on proximity to the particular controller (e.g., one of 160, 560 or 140, 540). At process step 630, the method 600 continues employing the user device 196, 596 to communicate with the controller (e.g., one of 160, 560 or 140, 540) to control an aspect of operation of the HVAC system 100, 500. The aspects of operation can include commissioning, programing or modification of operational parameters and functions, diagnostics, identifying fault codes, prognostics, updates, and the like.

The terminology used herein is for the purpose of describing particular embodiments only and is not intended to be limiting. While the description has been presented for purposes of illustration and description, it is not intended to be exhaustive or limited to the form disclosed. Many modifications, variations, alterations, substitutions, or equivalent arrangement not hereto described will be apparent to those of ordinary skill in the art without departing from the scope of the disclosure. Additionally, while the various embodiments have been described, it is to be understood that aspects may include only some of the described embodiments. Accordingly, embodiments are not to be seen as being limited by the foregoing description, but is only limited by the scope of the appended claims.

What is claimed is:

1. An HVAC system configured to interface with a user device, the HVAC system comprising:
a controller, the controller configured operate at least one unit of an HVAC system;
at least one of: the controller configured to conduct a first automatic identification of the user device and initiate communication between the controller and the user device or the user device configured to conduct a second automatic identification the controller and initiate communication between the user device and the controller;
the controller operably connecting to the user device, and the user device configured to operably communicate with the controller to control an aspect of operation of the HVAC system.

2. The HVAC system of claim 1, further including the user device configured to:
provide a graphical user interface to the HVAC system;
receive user input for performing a function of the HVAC system; and
instruct the HVAC system to perform the function.

3. The HVAC system of claim 1, wherein the user device comprises at least one of a mobile device, a smartphone, PDA, tablet, or wearable device.

4. The HVAC system of claim 1, wherein the controller is at least one of a unit controller or a system controller configured to control one or more units of the HVAC system.

5. The HVAC system of claim 1, wherein at least one of the user device and the controller are configured to communicate with the HVAC system over at least one of a wired connection and a wireless connection.

6. The HVAC system of claim 5, wherein the wireless connection is at least one of Bluetooth, WiFi, NFC, and Cellular.

7. The HVAC system of claim 1, wherein the aspect of operation includes at least one of commissioning a component of the HVAC system, programming a component of the HVAC system, diagnosing the HVAC system, displaying, modifying or changing variable of the HVAC system, updating software of the HVAC system, wherein the variable comprises a parameter for a compressor, blower, economizer, or fan of the HVAC system.

8. The HVAC system of claim 1, wherein the first automatic identification or the second automatic identification is based on at least one of a credential of a user, a profile of a user, and proximity of the user device to an HVAC system component.

9. The HVAC system of claim 8, wherein proximity is based on at least one of GPS location, Bluetooth beacon locations, wireless triangulation.

10. The HVAC system of claim 1, wherein at least one of the unit and the HVAC system comprises an outdoor commercial rooftop unit.

11. A method for operating a HVAC system, the method comprising:
identifying automatically a controller of an HVAC system and initiating communication between a user device and the controller of the HVAC system or identifying automatically a user device of an HVAC system and initiating communication between a controller and the user device of the HVAC system;
operably connecting the user device to the controller; and
communicating between the user device and the controller to control an aspect of operation of the HVAC system.

12. The method of claim 11, further including the user device configured to:
providing a graphical user interface on the user device to the HVAC system;
receiving user input via the user device for performing a function of the HVAC system; and
instructing the HVAC system via the user device to perform the function.

13. The method of claim 11, wherein the user device comprises at least one of a mobile device, a smartphone, PDA, tablet, or wearable device.

14. The method of claim 11, wherein the controller is at least one of a unit controller or a system controller configured to control one or more units of the HVAC system.

15. The method of claim 11, further comprising operating at least one of the user device and the controller to communicate with the HVAC system over at least one of a wired connection and a wireless connection.

16. The method of claim 15, wherein the wireless connection is at least one of Bluetooth, WiFi, NFC, and Cellular.

17. The method of claim 11, wherein at least one of the unit and the HVAC system comprises an outdoor commercial rooftop unit.

18. The method of claim 11, wherein the aspect of operation includes at least one of commissioning a component of the HVAC system, programming a component of the HVAC system, diagnosing the HVAC system, displaying, modifying or changing variable of the HVAC system, updating software of the HVAC system, wherein the variable comprises a parameter for a compressor, blower, economizer, or fan of the HVAC system.

19. The method of claim 11, wherein the identifying is based on at least one of a credential of a user, a profile of a user, and proximity of the user device to an HVAC system component.

20. The method of claim 19, wherein proximity is based on at least one of GPS location, Bluetooth beacon locations, wireless triangulation.
